(19) United States
(12) Patent Application Publication
(10) Pub. No.: US 2010/0269296 A1
(43) Pub. Date: Oct. 28, 2010

(54) HINGE

(75) Inventor: CHUNG-YI LIN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/496,659

(22) Filed: Jul. 2, 2009

(30) Foreign Application Priority Data
Apr. 28, 2009 (CN) 200910301926.3

(51) Int. Cl. E05D 11/08

(52) U.S. Cl. 16/342

(57) ABSTRACT

A hinge includes a rack, a shaft, a bracket, a first stop member, and a second stop member. The shaft includes a post, and an engaging portion secured to the rack. The bracket defines a pivot hole extending through a first side to a second side of the bracket. The bracket includes a first restricting block extending from the first side and a second restricting block extending towards the second side. The first stop member contacts with the first side of the bracket and forms a first stop portion to resist against the first restricting block of the bracket. The second stop member contacts with the second side of the bracket and forms a second stop portion to resist against the second restricting block of the bracket.

### BACKGROUND

1. Technical Field

The disclosure relates to a hinge.

2. Description of Related Art

A collapsible device, such as a notebook computer, or a clamshell mobile phone, generally including a main body and a cover often uses a hinge to interconnect the main body and the cover. The hinge allows the cover to be rotatable with respect to the main body, and to be folded with the main body for saving space.

A hinge normally includes a first element and a second element fixed to the main body and the cover of the collapsible device, respectively. The first and second elements are rotatable relative to and in friction engagement with each other for maintaining the cover at an angle with respect to the main body. During rotation, the cover can maintain at an angle with respect to the main body by friction between the first and second elements. However, the first and second elements are not durable after frequent usage and due to wear and tear, resulting in preventing the cover from being able to stay at certain desirable positions. When one of the first and second elements is worn out, the cover cannot maintain stability at certain desirable positions with respect to the main body, which creates quite an inconvenience for users. Even worse, the cover can be over-rotated by enough force resulting in damaging the hinge.

### BRIEF DESCRIPTION OF THE DRAWINGS

FIG. 1 is an assembled, isometric view of an exemplary embodiment of a hinge.

FIG. 2 is an exploded, isometric view of the hinge of FIG. 1

FIG. 3. is similar to FIG. 2, but viewed from another perspective.

FIG. 4 is a partial, assembled, and isometric view of the hinge of FIG. 1, and showing a using state.

### DETAILED DESCRIPTION

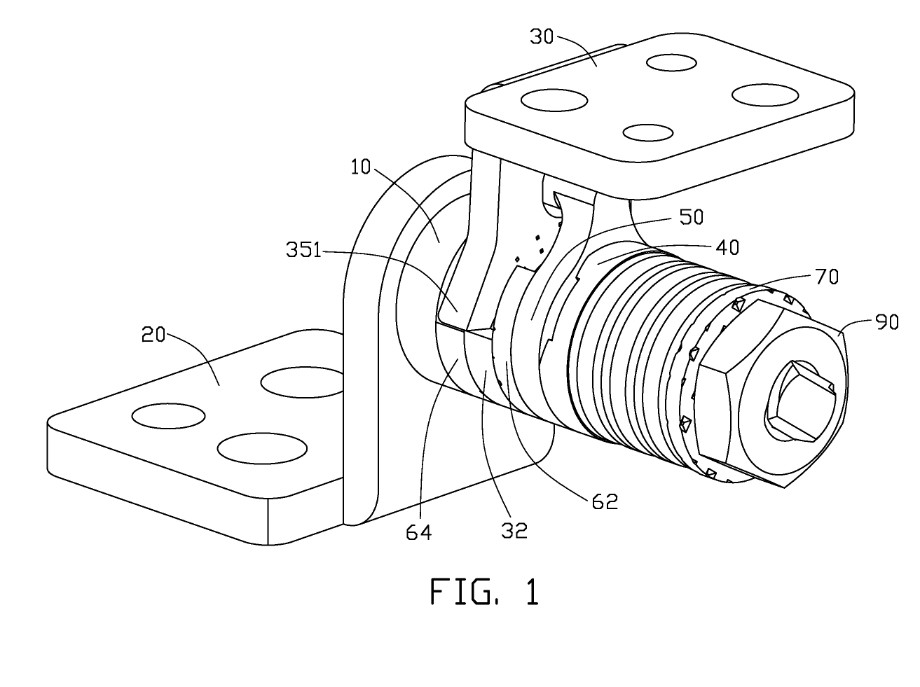

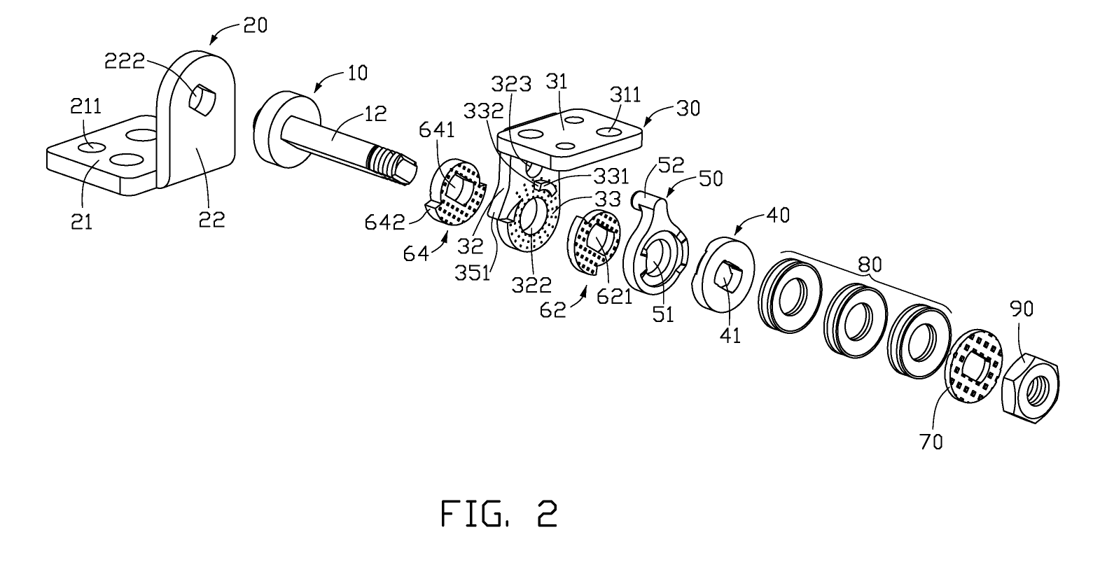

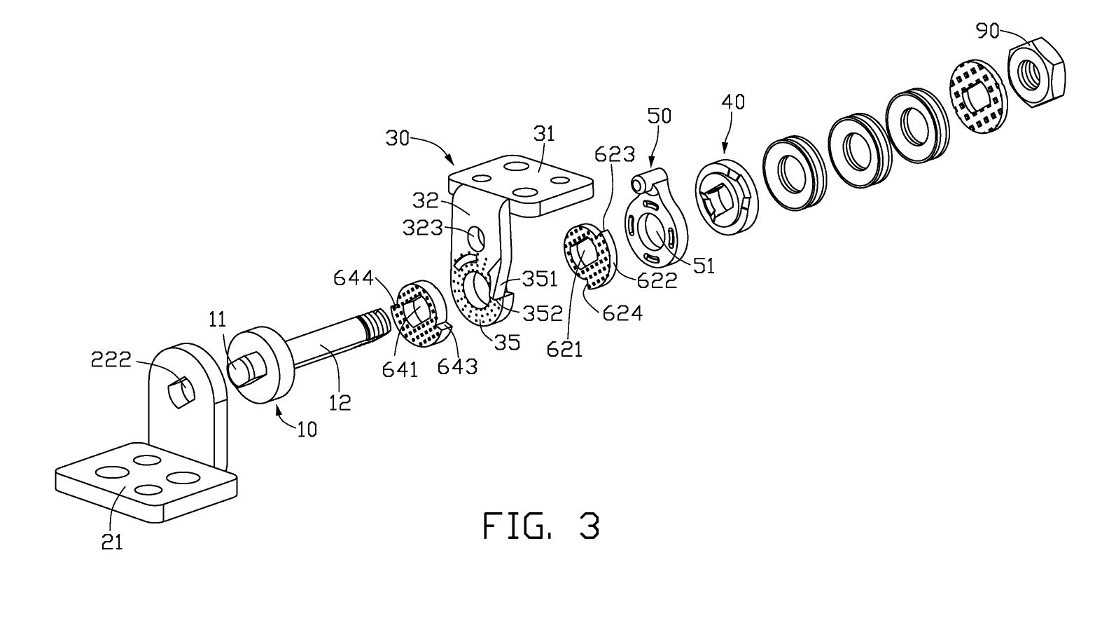

Referring to FIGS. 1 to 3, an exemplary embodiment of a hinge is adapted to be mounted to a collapsible device, such as a notebook or a clamshell mobile phone, that includes two parts rotatably connected to each other via the hinge. The hinge includes a shaft 10, a rack 20, a bracket 30, a first interfering member 40, a second interfering member 50, a first stop member 62, a second stop member 64, a washer 70, a resilient assembly 80, and a fastener 90.

The shaft 10 includes a generally cylindrical-shaped head (not labeled), with a post 12 and an engaging portion 11 protruding from opposite sides of the head. The post 12 has a noncircular, such as double-D shaped, cross section. A distal end away from the head of the post 12 forms a threaded portion. A cross section of the engaging portion 11 is noncircular to fix the shaft 10 to the rack 20. In other embodiments, the cross section of the engaging portion 11 may be any other shape that also enables the shaft 10 to be fixed to the rack 20.

The rack 20 includes a main body 21 and a flange 22 perpendicularly connected to an end of the main body. The flange 22 defines a noncircular engaging hole 222, corresponding to the engaging portion 11 of the shaft 10. A plurality of securing holes 211 are defined in the main body 21, for mounting the rack 20 to one part of the collapsible device (not shown).

The bracket 30 includes a main body 31 and a flange 32 perpendicularly extending from a side of the main body 31. The main body 31 defines a plurality of securing holes 311 therein, for mounting the bracket 30 to the other part of the collapsible device (not shown). The flange 32 defines a round pivot hole 322 extending through a first side 33 to a second side 35 of the flange 32, for rotatably receiving the post 12 of the shaft 10. The flange 32 also defines a positioning hole 323 adjacent to the pivot hole 322. An arc-shaped first restricting block 331 is formed on the first side 33 of the flange 32 around the pivot hole 322 and between the positioning hole 323 and the pivot hole 322. One end of the first restricting block 331 forms a restricting surface 332. The other end of the first restricting block 331 forms an inclined surface connecting to the first side 33 of the flange 32. A second restricting block 351 extends from a side of the flange 32 towards the second side 35 of the flange 32. A second restricting surface 352 is formed from a distal end of the second restricting block 351. A plurality of receiving holes (not labeled) is defined in the flange 32, around the pivot hole 322 for retaining lubricant.

The first interfering member 40 defines a double-D shaped through hole 41, corresponding to the post 12 of the shaft 10, to snugly fit about the post 12. A side of the first interfering member 40 facing the second interfering member 50 forms a first engaging portion (not labeled), such as a recessed portion in the illustrated embodiment.

The second interfering member 50 defines a round through hole 51, for rotatably receiving the post 12. A side of the second interfering member 50 facing the first interfering member 40 forms a second engaging portion (not labeled), such as a raised portion in the illustrated embodiment, to engage with the first engaging portion of the first interfering member 40. An inserting portion 52 is formed on a circumference of the second interfering member 50, for being inserted into the positioning hole 323 of the bracket 30, to fix the second interfering member 50 to the bracket 30.

The first and second stop members 62, 64 are similar to each other, and are generally washer-shaped. The first and second stop members 62, 64 are attached to the first side 33 and the second side 35 of the flange 32 of the bracket 30, respectively. Each of the first and second stop members 62, 64 defines a shaft hole 621, 641 in a center thereof, having a double-D shape, corresponding to the post 12 of the shaft 10, for unrotatably fitting about the post 12 of the shaft 10. Each of the first and second stop members 62, 64 defines an arc-shaped cutout (not labeled) along a circumference thereof. The first stop member 62 forms a first stop portion 622 opposite to the corresponding arc-shaped cutout. The first stop portion 622 includes two first stop surfaces 623, 624 at opposite ends thereof. The second stop member 64 forms a second stop portion 642 opposite to the arcuate cutout. The second stop portion 642 includes two second stop surfaces 643, 644 at opposite ends thereof. A plurality of receiving holes (not labeled) is defined in opposite sides of the first and second stop members 62, 64, for retaining lubricant.

The washer 70 defines a double-D shaped through hole in a center thereof, to snugly fit about the post 12. Opposite sides of the washer 70 define a plurality of receiving holes, for retaining lubricant.

The resilient assembly 80 includes a plurality of resilient frictional washers. These washers are stacked together, and rotationally retained around the post 12. In another embodiment, the resilient assembly 80 can be a spring or other resilient component. The fastener 90 is a hexagonal nut, and can be screwed to the threaded portion of the post 12.

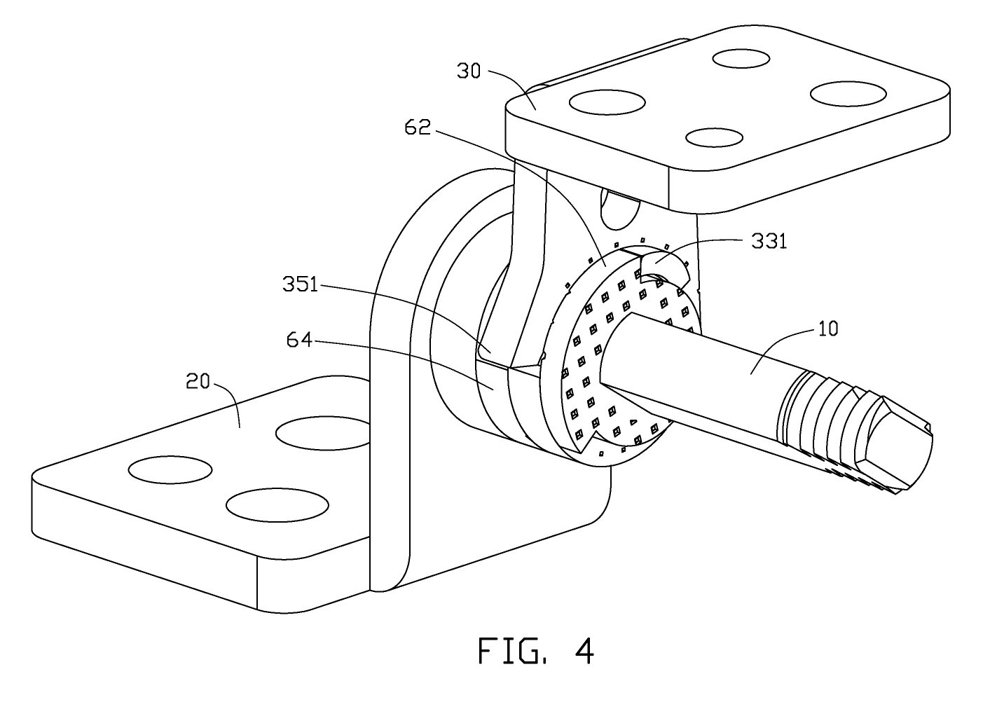

Referring to FIGS. 1 through 4, in assembly, the engaging portion 11 of the shaft 10 is inserted into the engaging hole 222 of the rack 20. The post 12 of the shaft 10 is inserted in the shaft hole 641 of the second stop member 64, extending through the pivot hole 322 of the bracket 30, the shaft hole 621 of the first stop member 62, the through hole 51 of the second interfering member 50, the through hole 41 of the first interfering member 40, the resilient assembly 80, and the through hole of the washer 70 in that order, to be screwed to the fastener 90. The inserting portion 52 of the second interfering member 50 is inserted into the positioning hole 323 of the bracket 30. The second engaging portion of the second interfering member 50 is engaged with the first engaging portion of the first interfering member 40.

In use, the shaft 10 rotates in the pivot hole 322 of the bracket 30. After the shaft 10 rotates an angle in a first direction, the restricting surface 332 of the first restricting block 331 of the bracket 30 resists against the first stop surface 623 of the first stop member 62, and the restricting surface 352 of the second restricting block 351 of the bracket 30 resists against the second stop surface 643 of the second stop member 64, to prevent the shaft 10 from further rotating.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A hinge, comprising:
a rack;
a shaft comprising a post, and an engaging portion secured to the rack;
a bracket defining a pivot hole extending through a first side to a second side of the bracket, the bracket comprising a first restricting block extending from the first side and a second restricting block extending out from the second side;
a first stop member contacting with the first side of the bracket, and comprising a first stop portion to resist against the first restricting block of the bracket; and
a second stop member contacting with the second side of the bracket, and comprising a second stop portion to resist against the second restricting block of the bracket.

2. The hinge of claim 1, further comprising a first interfering member and a second interfering member engaging with the first interfering member, wherein a cross section of the post is noncircular, the first interfering member is retained around the post, and defines a noncircular through hole snugly fitting about the post to allow the first interfering member rotate with the post, the second interfering member is mounted to the bracket, the post is rotatably inserted through the second interfering member.

3. The hinge of claim 2, further comprising a resilient assembly and a fastener, wherein the resilient assembly is rotatably retained around the post, the fastener is fixed to a distal end of the post to limit the second interfering member, the first interfering member, the first and second stop members, the bracket and the resilient assembly on the post, and the resilient assembly is located between the first interfering member and the fastener.

4. The hinge of claim 3, wherein the resilient assembly comprises a plurality of resilient frictional washers, these washers are stacked together and rotationally retained around the post.

5. The hinge of claim 2, wherein the bracket defines a positioning hole, the second interfering member forms an inserting portion inserted into the positioning hole to fix the second interfering member to the bracket.

6. The hinge of claim 1, wherein the bracket comprises a main body and a flange perpendicularly extending from a side of the main body, the pivot hole is defined in the flange, for rotatably receiving the post of the shaft, the first restricting block is arc-shaped and formed around the pivot hole of the flange, the second restricting block extends from a side of the flange towards the second side of the flange.

7. The hinge of claim 6, wherein one end of the first restricting block comprises a restricting surface for resisting against the first stop portion of the first stop member.

8. The hinge of claim 6, wherein the second restricting block comprises a second restricting surface on an distal end of the second restricting block, for resisting against the second stop portion of the second stop member.

9. The hinge of claim 8, wherein the first and second stop members are generally washer-shaped, each of the first and second stop members defines a shaft hole in a center, wherein the shaft hole has a double-D shape, corresponding to the post of the shaft, for unrotatably fitting about the post of the shaft.

10. The hinge of claim 1, wherein the first stop portion is formed along a circumference of the first stop member, the first stop portion comprises a first stop surface for resisting against the first restricting block of the bracket, the second stop portion is formed along a circumference of the second stop member, the second stop portion comprises a second stop surface for resisting against the second restricting block of the bracket.

11. A hinge, comprising:
a rack with a shaft fixed thereto, the shaft comprising a post;
a bracket defining a pivot hole for rotatably receiving the post therein, the bracket comprising a first restricting block and a second restricting block at opposite sides of the bracket;
a first interfering member defining a through hole to snugly fit about the post to allow the first interfering member rotate with the post;
a second interfering member mounted to the bracket engaging with the first interfering member to assist in the rotation of the post of the shaft in the pivot hole of the bracket;
a first stop member contacting with a first side of the bracket and forming a first stop portion to resist against the first restricting block of the bracket;
a second stop member contacting with a second side opposite to the first side of the bracket, and comprising a second stop portion to resist against the second restricting block of the bracket;
a resilient assembly rotatably fitting about the post; and
a fastener fixed to a distal end of the post to limit the second interfering member, the first interfering member, the first and second stop members, the bracket and the resilient assembly on the post.

12. The hinge of claim 11, wherein the bracket comprises a main body and a flange perpendicularly extending from a side of the main body, the pivot hole is defined in the flange, the first restricting block is arc-shaped and formed around the pivot hole of the flange, the second restricting block extends from a side of the flange towards the second side of the flange.

13. The hinge of claim 12, wherein one end of the first restricting block forms a restricting surface for resisting against the first stop portion of the first stop member.

14. The hinge of claim 12, wherein the second restricting block forms a second restricting surface from a distal end of the second restricting block, for resisting against the second stop portion of the second stop member.

15. The hinge of claim 14, wherein the first and second stop members are generally washer-shaped, each of the first and second stop members defines a shaft hole in a center, for unrotatably fitting about the post of the shaft.
